(19) United States
(12) Patent Application Publication
(10) Pub. No.: US 2010/0124061 A1
(43) Pub. Date: May 20, 2010

(54) Heat-dissipation structure of matrix LED light

(76) Inventor: Hsu-Li Yen, Sinjhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,229

(22) Filed: Nov. 14, 2008

(51) Int. Cl. F21V 33/00

(52) U.S. Cl. 362/253

(57) ABSTRACT

A heat-dissipation structure of a matrix LED light includes a heat-dissipation unit coupled to a matrix LED light chip, and a seat housing, so as to provide rapid heat dissipation and thereby maintain a low temperature. The seat housing has a plurality of vent holes for air to pass through so as to circulate between the seat housing, the matrix LED light chip, and the heat-dissipation unit. Thus, the heat-dissipation unit can absorb and rapidly dissipate heat generated by the matrix LED light chip, allowing the matrix LED light chip to remain at a low temperature, preventing the matrix LED light from premature aging, and thereby increasing its service life.

### BACKGROUND OF THE INVENTION

1. Technical Field

The present invention relates to a heat-dissipation structure of a matrix LED light, and more particularly, to a lamp heat-dissipation structure of a matrix LED light.

2. Description of Related Art

Nowadays, various kinds of lamps are used to bring light to our living space. The lamps are placed at desired locations to change the brightness of the space with the light they emit. As essential illumination devices in our daily life, the lamps not only help enhance the quality of our living space, but are also closely related to our physical health, especially the eyes.

Generally, basic lighting is necessary to provide sufficient illumination for good vision. Therefore, the stability of illumination light has direct impact on the health of the eyes. Besides, public attention has been drawn to environmental protection issues associated with the raw materials, production and recycling of lamps, and their high power consumption during illumination.

Recently, there is negative news coverage worldwide about the effects of traditional lamps on human bodies and the environment, and it has been a global trend to replace traditional lamps with matrix LED light chips which cause neither environmental protection problems nor damage to human health. Particularly, the matrix LED light chips are power-efficient, provide brighter and more stable illumination than the traditional lamps, and are therefore qualified as excellent lighting devices.

However, heat is generated when a matrix LED light chip emits light. Therefore, when a matrix LED light chip is combined with a lamp seat housing, a lamp cover, etc. to form a lamp, the matrix LED light may undergo premature aging and expire faster than it should if the heat cannot be dissipated effectively.

In order to solve the heat dissipation problem of matrix LED light chips, the inventor of the present invention took pains in finding a way to improve heat dissipation and lower the temperature of matrix LED light chips. After repeated research and experiments, the present inventor finally succeeded in developing a structural design that allows a matrix LED light chip to remain at a low temperature.

### SUMMARY OF THE INVENTION

Therefore, it is an objective of the present invention to provide a heat-dissipation structure of a matrix LED light, wherein the heat-dissipation structure comprises a heat-dissipation unit coupled to a matrix LED light chip, and a seat housing, so as to provide rapid heat dissipation and thereby maintain a low temperature. The seat housing has a plurality of vent holes for air to pass through so as to circulate between the seat housing, the matrix LED light chip, and the heat-dissipation unit. Thus, the heat-dissipation unit can absorb and rapidly dissipate heat generated by the matrix LED light chip, allowing the matrix LED light chip to remain at a low temperature, preventing the matrix LED light from premature aging, and thereby increasing its service life.

To achieve this end, the present invention provides a heat-dissipation structure of a matrix LED light, wherein a heat-dissipation unit has an upper surface in contact with a lower surface of a matrix LED light chip so as to absorb heat generated by the matrix LED light chip. A seat housing is formed with vent holes to allow air to pass through so as to circulate between the seat housing, the heat-dissipation unit, and the matrix LED light chip, thereby achieving rapid heat dissipation. The heat-dissipation unit comprises a plurality of radial plates for increasing area of contact with air so as to enhance heat dissipation. Thus, the matrix LED light chip is allowed to remain at a low temperature and have a longer service life.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is an exploded, perspective view of a heat-dissipation structure of a matrix LED light according to the present invention;

FIG. 2 is a cross-sectional perspective view of the heat-dissipation structure of the matrix LED light according to the present invention;

FIG. 3 is a perspective view of a heat-dissipation unit of the heat-dissipation structure of the matrix LED light according to the present invention; and

FIG. 4 is a perspective view of the heat-dissipation structure of the matrix LED light according to the present invention.

### DETAILED DESCRIPTION OF THE EMBODIMENT

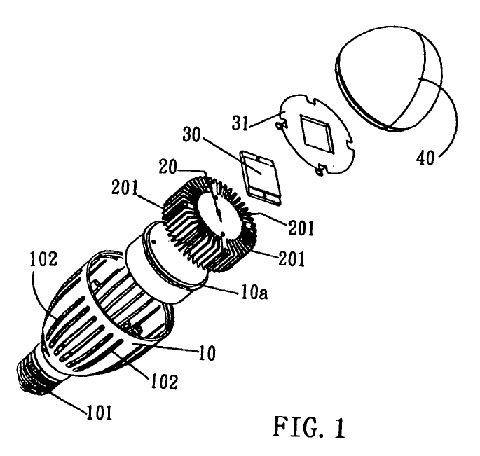

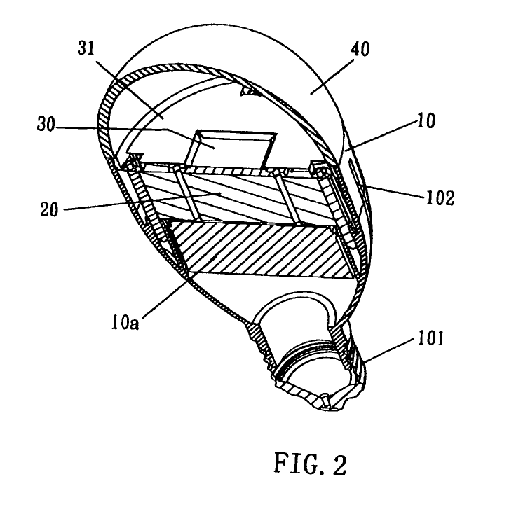

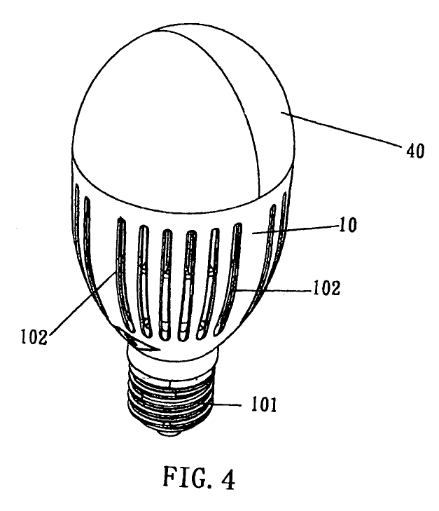

FIG. 1 is an exploded, perspective view of a heat-dissipation structure of a matrix LED light according to the present invention, wherein the heat-dissipation structure comprises a seat housing 10 formed with a connector 101, a circuit unit 10a, a heat-dissipation unit 20, a matrix LED light chip 30, a frame 31, and a transparent shield 40 firmly coupled to one another so as to form an illumination lamp (as shown in FIG. 2 and FIG. 4, too).

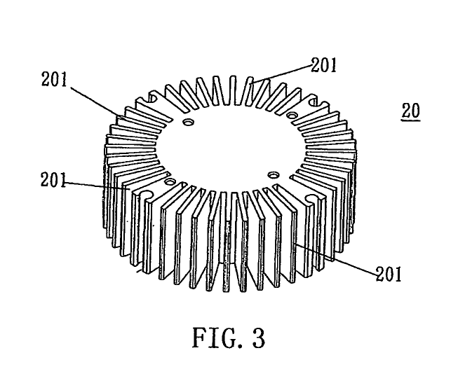

Referring to FIG. 3, the heat-dissipation unit 20 is made of metal and comprises a plurality of metal plates 201 protruding from, and arranged at intervals around 360 degrees of, a metal rim of the heat-dissipation unit 20 in radial directions, so as to increase area of contact with air and accelerate heat dissipation.

The heat-dissipation unit 20 has an upper surface in contact with a lower surface of the matrix LED light chip 30, and is fixed in position within the seat housing 10. The seat housing 10 has a plurality of vent holes 102 for allowing air to enter, circulate in, and exits the seat housing 10, as shown in FIGS. 1, 2 and 4.

FIG. 2 is a cross-sectional view of the heat-dissipation structure of the matrix LED light according to the present invention. As shown in the drawing, the matrix LED light chip 30 is screwed to and therefore secured in position to the heat-dissipation unit 20, so that the lower surface of the matrix LED light chip 30 is in contact with the upper surface of the heat-dissipation unit 20. Heat generated by the matrix LED light chip 30 during illumination is absorbed by the heat-dissipation unit 20 and then conducted to the metal plates 201 thereof. The vent holes 102 of the seat housing 10 allow air to enter and exit, and circulate between the heat-dissipation unit 20 and the matrix LED light chip 30, thereby enhancing heat dissipation and cooling. Particularly, the metal plates 201 protruding, in radial directions and at intervals, from the heat-dissipation unit 20 increase area of contact with air and thereby enhance heat dissipation. Hence, the matrix LED light chip 30 is kept at a low temperature and prevented from premature aging, thereby resulting in prolonged service life.

In conclusion, the heat-dissipation structure of the present invention not only provides the intended cooling effect, but also involves an inventive step. Moreover, the present invention has not been put to public use and meets the requirements of utility and novelty for patent application. Hence, an application for patent of the present invention is hereby filed for examination.

The present invention has been described with a preferred embodiment thereof and it is understood that the embodiment is not intended to limit the scope of the present invention. Therefore, all equivalent changes or modifications which are based on the concept of the present invention and whose functions and effects do not depart from the spirit of the present invention as disclosed herein are encompassed by the appended claims.

What is claimed is:

1. A heat-dissipation structure of a matrix LED light, comprising a seat housing formed with a connector, a circuit unit, a heat-dissipation unit, a matrix LED light chip, a frame, and a transparent shield firmly coupled to one another so as to form an illumination lamp, the heat-dissipation structure being characterized in that:
the heat-dissipation unit is made of metal and comprises a plurality of metal plates protruding from, and arranged at intervals around 360 degrees of, a metal rim of the heat-dissipation unit in radial directions; and the seat housing has a plurality of vent holes for allowing air to enter, circulate in, and exit the seat housing.

2. The heat-dissipation structure of the matrix LED light of claim 1, wherein the heat-dissipation unit has an upper surface in contact with a lower surface of the matrix LED light chip and is fixed in position within the seat housing, wherein the vent holes of the seat housing allow air to enter, circulate in, and exit the seat housing so as to enhance heat dissipation.

3. The heat-dissipation structure of the matrix LED light of claim 1, wherein heat generated by the matrix LED light chip during illumination is absorbed by the heat-dissipation unit and then conducted to the metal plates thereof, and the vent holes of the seat housing allow air to enter and exit, and circulate between the heat-dissipation unit and the matrix LED light chip, thereby enhancing heat dissipation and cooling, in which the metal plates protruding, in radial directions and at intervals, from the heat-dissipation unit increase area of contact with air and thereby enhance heat dissipation.
